(19) United States
(12) Patent Application Publication
(10) Pub. No.: US 2013/0152108 A1
(43) Pub. Date: Jun. 13, 2013

(54) METHOD AND APPARATUS FOR VIDEO PROCESSING

(71) Applicants: Yinan Jiang, Toronto (CA); Ting-Yu Lin, Markham (CA); Jing Sha, Vaughan (CA); Huan Xu, Shanghai (CN); Fanfan Gu, Shanghai (CN)

(72) Inventors: Yinan Jiang, Toronto (CA); Ting-Yu Lin, Markham (CA); Jing Sha, Vaughan (CA); Huan Xu, Shanghai (CN); Fanfan Gu, Shanghai (CN)

(73) Assignees: ATI TECHNOLOGIES ULC, Markham (CA); ADVANCED MICRO DEVICES, INC., Sunnyvale, CA (US)

(21) Appl. No.: 13/324,489

(22) Filed: Dec. 13, 2011

(51) Int. Cl. G06F 3/00

(52) U.S. Cl. 719/321

(57) ABSTRACT

A method and system for video processing is disclosed. A device driver interface (DDI) call for flipping or updating an overlay may be skipped or ignored, and may not be used by a user mode driver to pass overlay properties to a kernel mode driver (KMD). Instead, the overlay properties may be passed to the KMD at rendering time during a DDI call for rendering. The user mode driver may call a DDI for rendering an overlay frame while simultaneously passing the overlay property data to the KMD. The KMD may store the overlay property data in an overlay flip queue, program the overlay hardware per the overlay property data stored in the overlay flip queue, and flip the overlay in response to the vertical synchronization deferred procedure call.

### FIELD OF THE INVENTION

This application is related to a computer processor, and more particularly, to video processing.

### BACKGROUND

An overlay is an independent layer above a primary surface, (e.g., an overlay on top of a desktop background). The overlay is often used for the purposes of copy protection, hardware acceleration, or the like during video playback. Current driver design to support overlays in Microsoft® Windows Display Driver Model (WDDM), for example, involves device driver interface (DDI) calls, virtual command OP-codes (VCOPs), and vertical synchronization deferred procedure calls (VSYNC DPCs).

Currently, the DDI calls and the VSYNC DPCs are on two separate threads with two different execution priorities. They often perform the same tasks but are out of synchronization with each other. Due to this lack of synchronization, the video may appear to be out of position with the playback window. This may occur, for example, when a user moves a playback window across a GUI desktop by dragging it with a mouse cursor.

To solve the synchronization problem, the VSYNC may be turned off and using VSYNC DPCs to update the overlay frames may be stopped. However, the main reason for using VSYNC DPCs and interrupt request (IRQ) flips is to be able to check if rendering is complete before flipping the overlay. Without VSYNC DPCs, there is no check so that tearing of the video may be visible.

### SUMMARY OF EMBODIMENTS

A method and system for updating a video overlay property in video processing (e.g., playback) is disclosed. Specific calls for flipping or updating the overlay, such as the DxgkDdiFlipOverlay and DxgkDdiUpdateOverlay calls, may be skipped by the user mode driver or ignored by the kernel mode driver (KMD). The DxgkDdiFlipOverlay and DxgkDdiUpdateOverlay calls may not be used by the user mode driver to pass the overlay property to the KMD. Even if these two DDI calls are received by the KMD, the KMD may not perform any operation upon the call. Instead, the overlay property may be passed to the KMD at rendering time during a DDI call for rendering, such as DxgkDdiRender. A user mode driver may call a DDI for rendering an overlay frame while passing the overlay property data of an overlay to the KMD simultaneously. The KMD may store the overlay property data in an overlay flip queue. The KMD may then flip the overlay and program the overlay hardware per the overlay property data stored in the overlay flip queue in response to the vertical synchronization deferred procedure call (VSYNC DPC). With this scheme, rendered overlay frames will be matched with the correct overlay property.

### BRIEF DESCRIPTION OF THE DRAWINGS

A more detailed understanding may be had from the following description, given by way of example in conjunction with the accompanying drawings wherein:

FIG. 1 is a block diagram of an example system in which one or more disclosed embodiments may be implemented;

FIG. 2 is a signaling diagram for overlay display in accordance with the conventional scheme; and

FIG. 3 is an example signaling flow for updating the overlay property in video playback in accordance with one embodiment.

### DETAILED DESCRIPTION OF EMBODIMENTS

The embodiments will be described with reference to the drawing figures wherein like numerals represent like elements throughout.

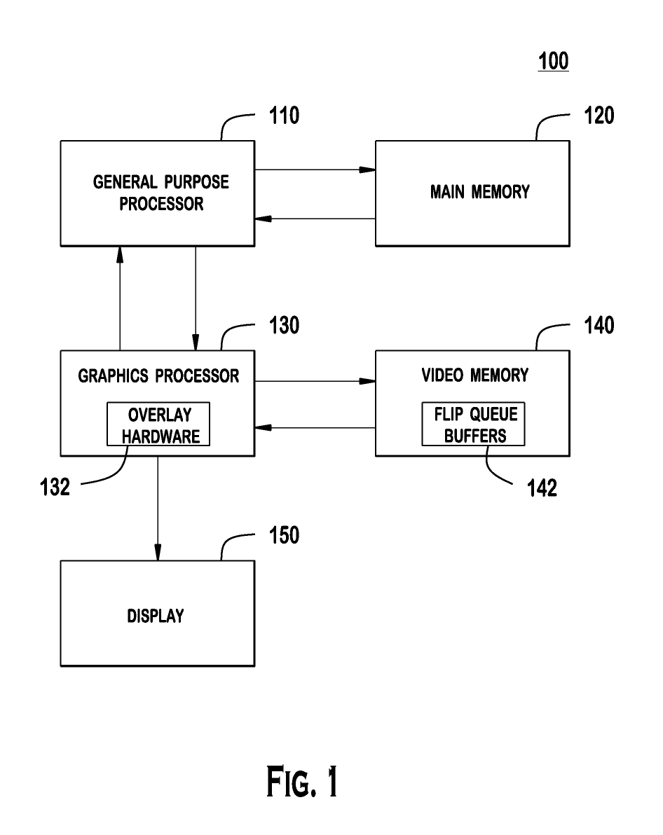

FIG. 1 shows an example system 100 in which one or more disclosed embodiments may be implemented. The system 100 may be, for example, a computer, a gaming device, a handheld device, a set-top box, a television, a mobile phone, or a tablet computer. The system 100 may include a general purpose processor (e.g., a central processing unit (CPU)) 110, a main memory 120, a graphics processor, (e.g., a graphics processing unit (GPU)) 130, a video memory 140, and a display 150. It should be understood that the system 100 may include additional components not shown in FIG. 1.

The general purpose processor 110 is configured to run applications, drivers including a display driver, and an operating system (OS). The graphics processor 130 is a specialized processor designed to accelerate building images in a frame buffer intended for output to the display 150. The graphics processor 130 includes overlay hardware 132 for generating the images for overlay.

The display driver, which is a software program executing on the general purpose processor 110, directs or drives the graphics processor 130 to display video data input into the graphics processor 130. The driver includes executable instructions run in the general purpose processor 110 to effect timing of the video data read out of the flip queue buffers 142 and displayed by the graphics processor 130 on the display 150. The driver is configured to be responsive to an interrupt signal received from the graphics processor 130 via the OS.

The video memory 140 is provided for storing video data that has been processed and ready for display by the graphics processor 130. The video memory 140 may contain one or more flip queue buffers 142 to temporarily store video data frames while awaiting display on the display 150. The flip queue buffers 142 may be allocated by the driver when a video playback is initiated by the application and are de-allocated at the conclusion of the video playback. The display 150 may be any type of electronic display device, such as a liquid crystal display (LCD) display, a light emitting diode (LED) display, a cathode ray tube (CRT) display, or the like. The display 150 may form part of the system 100 (e.g., included in a portable device such as a notebook, mobile phone, tablet, or the like) or be removably connected to the system 100 (e.g., a secondary display for portable device, a desktop, or may be remote from the system 100 such as in a server or wireless display arrangement).

It should be noted that the configuration shown in FIG. 1 is merely an example, and many variations are possible. For example, the general purpose processor 110 and the graphics processor 130 may be incorporated in one chip package, or may be one or more processor cores. Additionally, there may be several general purpose processors 110 and/or several graphics processors 130. The memory 120, 140 may be located on the same die as the processor 110, 130, or may be located separately from the processor 110, 130. The memory 120, 140 may include a volatile or non-volatile memory, for example, random access memory (RAM), dynamic RAM, a cache, and the like. A separate video memory 140 may be used as shown in FIG. 1, or alternatively, the video memory 140 may be part of the main memory 120. Although in FIG. 1, only one display 150 is shown, there may be multiple displays connected to the system 100, and the embodiments disclosed herein may be applied to a system 100 having more than one display/desktop.

The system 100 may also include a storage, an input device(s), and an additional output device(s) (not shown). The storage may include a fixed or removable storage, for example, a hard disk drive, a solid state drive, an optical disk, or a flash drive. The input device(s) may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices may include an additional display, a speaker, a printer, a haptic feedback device, one or more lights, an antenna, or a network connection (e.g., a wireless local area network card for transmission and/or reception of wireless IEEE 802 signals).

An input driver communicates with the processor 110, 130 and the input devices, and permits the processor 110, 130 to receive input from the input devices. An output driver communicates with the processor 110, 130 and output devices, and permits the processor 110, 130 to send output to the output devices. It is noted that the input driver and the output driver are optional components, and that the system 100 will operate in the same manner is the input driver and the output driver are not present.

The display driver model for the overlays involves interactions between the user mode multimedia driver (MMD), the kernel mode driver (KMD), and the OS. These interactions, in the exemplary Microsoft® Windows environment, are carried out by a number of DDI calls, VCOPs, and VSYNC DPCs. Hereafter, the embodiments will be explained with reference to Microsoft® Windows environment, but it should be noted that the embodiments are applicable to different environments as well.

In the conventional display model, there is a redundant set of function calls that carry out similar actions running on the separate threads. For example, DxgkDdiFlipOverlay, DxgkDdiUpdateOverlay, and the VSYNC DPC may program the overlay hardware to update the overlay position, size, frame address, etc. The DxgkDdiFlipOverlay function causes the overlay hardware to flip the buffer for the overlay (e.g., from the front buffer to the back buffer, or vice versa) and start displaying the overlay from the flipped buffer. The DxgkDdiUpdateOverlay function reconfigures or moves an overlay that is being displayed.

VSYNC is an option wherein a graphics processor is prevented from doing anything visible to a display memory until after the display has finished its current refresh cycle. During the vertical blanking interval, the driver may order the graphics processor to either rapidly copy the off-screen graphics area into the active display area (in the case of double buffering), or switch back and forth between buffers (in the case of page flipping).

A DPC is an OS mechanism which allows high-priority tasks to defer lower-priority tasks for later execution. This permits device drivers and other low-level event consumers to perform the high-priority part of their processing quickly, and schedule non-critical additional processing for execution at a lower priority. DPCs are implemented by DPC objects which are created and initialized by the kernel when a device driver or some other kernel mode program issues requests for a DPC.

The DDI calls (DxgkDdiFlipOverlay and DxgkDdiUpdateOverlay) and the VSYNC DPCs are running on separate threads with different priority levels. Therefore, the DDI calls and the VSYNC DPCs are not synchronized, which may cause the synchronization problem identified above, for example, when the playback window of the overlay is moved by a user. Since the VSYNC DPC is running at a higher priority level than the DDI calls (DxgkDdiFlipOverlay and DxgkDdiUpdateOverlay), the VSYNC DPC call may interrupt the DDI calls. As a consequence, the overlay may not flip to the correct position and size.

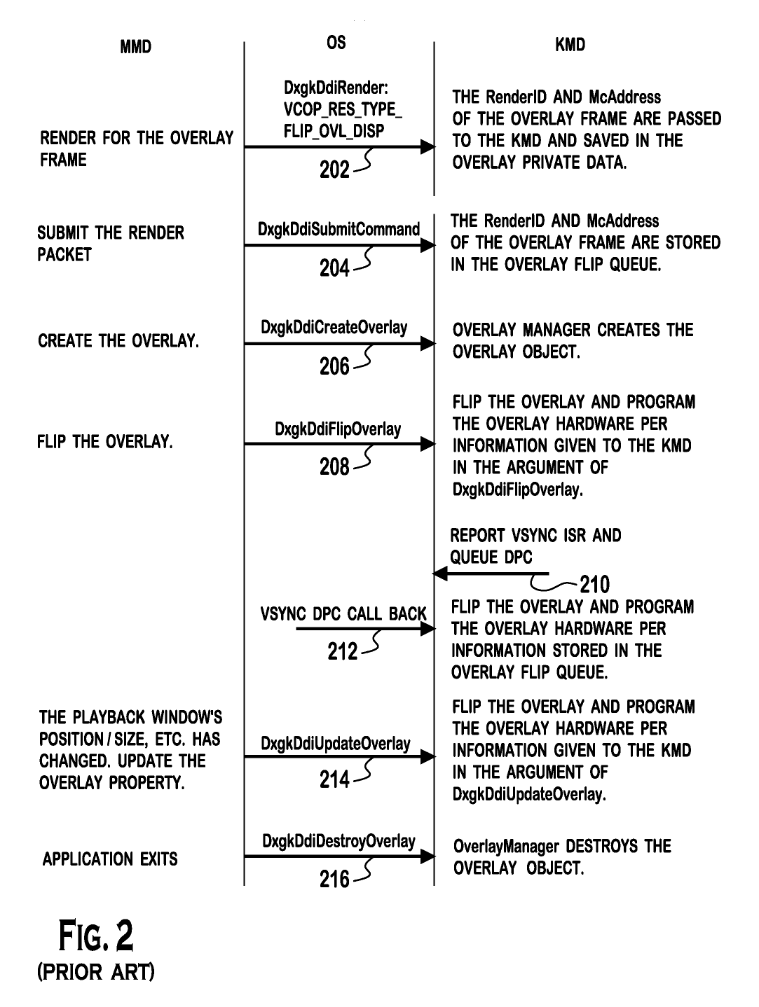

FIG. 2 is a signaling diagram for overlay display in accordance with a conventional scheme. The MMD calls DxgkDdiRender for rendering the overlay frame (202). The RenderID (an index of rendered overlay frames) and McAddress (overlay frame location in the view of the graphics processor 130) of the overlay frame are passed to the KMD, which saves them in the overlay private data to be used later. The MMD calls DxgkDdiSubmitCommand to submit the render packet, and the RenderID and the McAddress of the overlay frame are retrieved from the attached overlay private data and stored in the overlay flip queue buffer (204). The MMD calls DxgkDdiCreateOverlay and the KMD (i.e., OverlayManager) creates an overlay object (206). The DxgkDdiCreateOverlay function allocates overlay hardware and makes the overlay visible. To flip the overlay, the MMD calls DxgkDdiFlipOverlay (208). The KMD then flips the overlay and may program the overlay hardware per information given in the argument of DxgkDdiFlipOverlay. When a VSYNC interrupt service routine (ISR) issues (210), the KMD will queue a DPC request to the OS's DPC queue. The OS calls the VSYNC DPC call and the KMD then flips the overlay and programs the overlay hardware per information stored in the overlay flip queue buffer (212).

If the overlay playback window's size or position changes, the MMD calls DxgkDdiUpdateOverlay and the KMD programs the overlay hardware per information given in the argument of DxgkDdiUpdateOverlay (214). When the application exits, the MMD calls DxgkDdiDestroyOverlay, and the KMD (i.e., OverlayManager) destroys the overlay object (216).

In one embodiment, the DDI call for flipping or updating the overlay, such as the DxgkDdiFlipOverlay and DxgkDdiUpdateOverlay calls, may be skipped or ignored. The DxgkDdiFlipOverlay and DxgkDdiUpdateOverlay may not be used by the MMD to pass the overlay property, (i.e., position, size, and frame address of the overlay, etc.), to the KMD. Instead, the overlay property may be passed to the KMD at rendering time during a DDI call for rendering, such as a DxgkDdiRender call. In accordance with one embodiment, a user mode driver (i.e., the MMD) may call a device driver interface for rendering an overlay frame while passing the overlay property data of an overlay to the KMD simultaneously. The KMD may store the overlay property data in an overlay flip queue, flip the overlay, and program the overlay hardware per the overlay property data stored in the overlay flip queue in response to the VSYNC DPC. With this scheme, the rendered overlay frame will be matched with the correct overlay property.

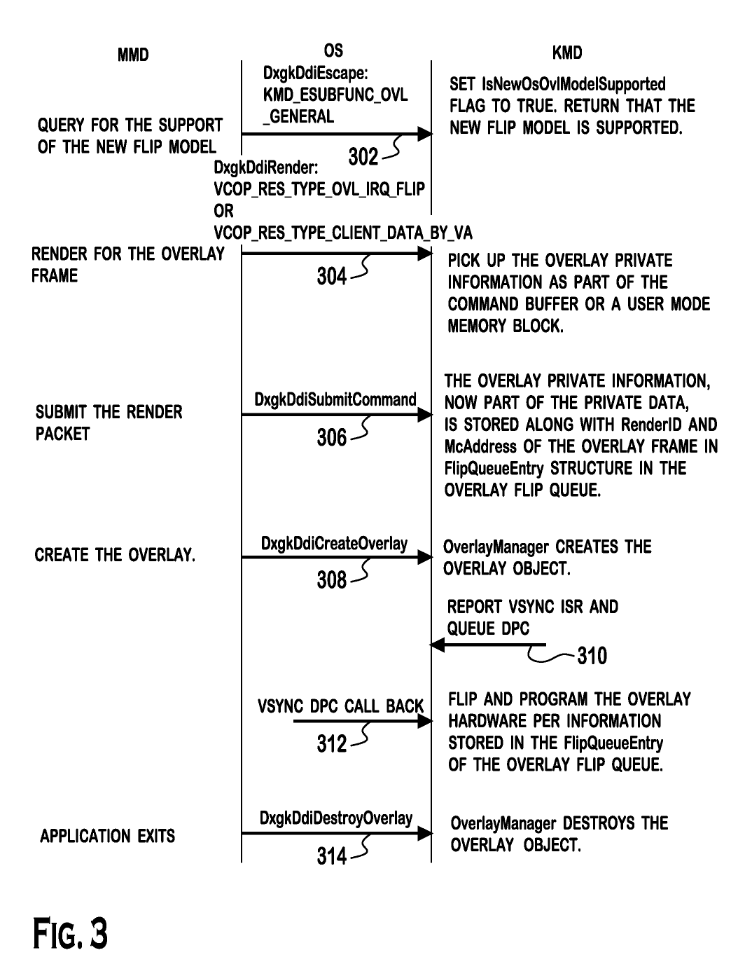

FIG. 3 is an example signaling flow for updating the overlay property in video playback. The MMD may query for the support of the new overlay flip model by calling DxgkDdiEscape (302). Since the MMD and the KMD may have different capabilities, this query may be performed to confirm that the KMD supports the new overlay flip model. If the new overlay flip model is supported, the KMD sets a flag, (e.g., IsNewOsOvlModelSupported), to true and returns that the new overlay flip model is supported.

The MMD calls DxgkDdiRender for rendering each overlay frame (304). A new VCOP (for example, VCOP_RES_TYPE_OVL_IRQ_FLIP or VCOP_RES_TYPE_CLIENT_DATA_BY_VA) is inserted by the MMD in the DxgkDdiRender call that indicates to the KMD that the new overlay model is being used and a command buffer or a user mode system memory block is used as a carrier of the overlay property data structure. One instance of the overlay property data structure may accompany the rendering of a single frame of the overlay. The KMD then picks up the overlay property information as part of the command buffer or the user mode system memory block and saves the overlay property information in the overlay private data along with the RenderID and McAddress.

The overlay property data structure includes change flags, color keys, color formats, overlay dimensions, overlay flags, tile information, overlay position, etc. The change flags indicate which overlay property has been changed since the last overlay frame. The color keys describe the background color of the overlay. The color formats indicate the color format of the overlay. The overlay dimensions indicate the size of the overlay window. The overlay flags are miscellaneous flags that describe the additional private features of the overlay. The tile information indicates the tile format of the overlay frame. The overlay position indicates the position of the overlay on the desktop.

The MMD calls DxgkDdiSubmitCommand to submit the render packet, and the KMD retrieves the overlay property data along with the RenderID and the McAddress of the overlay frame from the overlay private data, and then stores the overlay property data along with the RenderID and the McAddress of the overlay frame in the overlay flip queue (e.g., in FlipQueueEntry structure) (306). The MMD calls DxgkDdiCreateOverlay and the KMD, (i.e., OverlayManager), creates an overlay object (308). The DxgkDdiCreateOverlay function allocates the overlay hardware and makes the overlay visible.

At VSYNC DPC in response to the VSYNC ISR (310), the oldest instance of the overlay property structure may be retrieved from the overlay flip queue buffer and its contained data may be used to program the overlay hardware to flip the overlay to a new frame (312). If the change flags of the overlay property data indicate any change, the KMD programs the overlay hardware with the updated overlay property data and flips the overlay. If there is no change, the KMD just flips the overlay, and other overlay hardware properties are not reprogrammed. When the application exits, the MMD calls DxgkDdiDestroyOverlay, and the KMD, (i.e., OverlayManager), destroys the overlay object (314).

In this embodiment, since the overlay property data is passed during the DxgkDdiRender call, and the DxgkDdiFlipOverlay and DxgkDdiUpdateOverlay calls are skipped or simply ignored, the overlay is updated to a new frame during the VSYNC period, (i.e., video blanking interval (VBLANK)), and thus the tearing of the video is not observed by the user as is the case in conventional systems. In addition, with this scheme when a user moves the overlay playback window or changes the size of the overlay playback window, the position of the overlay will match with the rendered overlay frame, because the MMD passes the updated playback window position or size data during the rendering time for each overlay frame. As a result, no lagging of the video will be seen by the user.

Although features and elements are described above in particular combinations, each feature or element may be used alone without the other features and elements or in various combinations with or without other features and elements. The apparatus described herein may be manufactured by using a computer program, software, or firmware incorporated in a computer-readable storage medium for execution by a general or specific purpose computer or processor.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

A computer-readable storage medium may store a set of instructions for execution by a processor to perform updating video overlay property in video playback including a first code segment for calling a DDI call for rendering an overlay frame, wherein overlay property data of an overlay is passed to the KMD simultaneously with the DDI call for rendering; and a second code segment for programming an overlay hardware per the overlay property data and flipping the overlay in response to a VSYNC DPC. The overlay property data may include a flag indicating a change of the overlay property data, and the overlay hardware is programmed on a condition that there is any change in the overlay property data.

The storage medium may further include a code segment for setting a flag to indicate a support of an overlay flip model that the overlay property data is passed simultaneously with the DDI call for rendering in response to a query. The DDI call for rendering may include a command indicating that the overlay property data is passed simultaneously with the DDI call for rendering. The KMD may be configured to skip or ignore a DxgkDdiFlipOverlay call or a DxgkDdiUpdateOverlay call. The overlay property data is obtained as part of a command buffer or a user mode system memory block.

Examples of computer-readable storage mediums include, but are not limited to, a read-only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for video playback, comprising:
rendering an overlay frame, wherein overlay property data of an overlay is passed to a kernel mode driver (KMD) simultaneously with a device driver interface (DDI) call;
programming an overlay hardware per the overlay property data and flipping the overlay in response to a vertical synchronization deferred procedure call.

2. The method of claim 1, wherein the overlay property data includes a flag indicating a change of the overlay property data, and the overlay hardware is programmed on a condition that there is a change in the overlay property data.

3. The method of claim 1, further comprising:
the KMD receiving a query for support of an overlay flip model in which the overlay property data is passed simultaneously with the DDI call for rendering; and
the KMD setting a flag on a condition that the KMD supports the overlay flip model.

4. The method of claim 1, wherein the DDI call for rendering includes a command indicating that the overlay property data is passed simultaneously with the DDI call for rendering.

5. The method of claim 1, wherein a DDI call for flipping the overlay is skipped or ignored.

6. The method of claim 1, wherein a DDI call for updating the overlay is skipped or ignored.

7. The method of claim 1, wherein the overlay property data is passed to the KMD as part of a command buffer or a user mode system memory block.

8. A system for video playback, comprising:
a processor including an overlay hardware for generating images for overlays;
a user mode driver configured to call a device driver interface (DDI) call for rendering an overlay frame, wherein overlay property data of an overlay is passed to a kernel mode driver (KMD) simultaneously with the DDI call; and
the KMD configured to program the overlay hardware per the overlay property data and flip the overlay in response to a vertical synchronization deferred procedure call.

9. The system of claim 8, wherein the overlay property data includes a flag indicating a change of the overlay property data, and the overlay hardware is programmed on a condition that there is a change in the overlay property data.

10. The system of claim 8, wherein the KMD is configured to receive a query for support of an overlay flip model in which the overlay property data is passed simultaneously with the DDI call for rendering and set a flag on a condition that the KMD supports the overlay flip model.

11. The system of claim 8, wherein the DDI call for rendering includes a command indicating that the overlay property data is passed simultaneously with the DDI call for rendering.

12. The system of claim 8, wherein a DDI call for flipping the overlay or updating the overlay is skipped or ignored.

13. The system of claim 8, wherein the overlay property data is passed to the KMD as part of a command buffer or a user mode system memory block.

14. A computer-readable storage medium storing a set of instructions for execution by a processor to perform updating video overlay property in video playback, the set of instructions comprising:
a first code segment for calling a device driver interface (DDI) call for rendering an overlay frame, wherein overlay property data of an overlay is passed to the kernel mode driver (KMD) simultaneously with the DDI call for rendering;
a second code segment for programming an overlay hardware per the overlay property data and flipping the overlay in response to a vertical synchronization deferred procedure call.

15. The storage medium of claim 14, wherein the overlay property data includes a flag indicating a change of the overlay property data, and the overlay hardware is programmed on a condition that there is a change in the overlay property data.

16. The storage medium of claim 14, further comprising:
a code segment for receiving a query for support of an overlay flip model in which the overlay property data is passed simultaneously with the DDI call for rendering and setting a flag on a condition that the KMD supports the overlay flip model.

17. The storage medium of claim 14, wherein the DDI call for rendering includes a command indicating that the overlay property data is passed simultaneously with the DDI call for rendering.

18. The storage medium of claim 14, wherein a DDI call for flipping the overlay is skipped or ignored.

19. The storage medium of claim 14, wherein a DDI call for updating the overlay is skipped or ignored.

20. The storage medium of claim 14, wherein the overlay property data is obtained as part of a command buffer or a user mode system memory block.
